(19) United States
(12) Patent Application Publication
(10) Pub. No.: US 2005/0010460 A1
(43) Pub. Date: Jan. 13, 2005

(54) Facilities control system and method of controlling facilities

(76) Inventors: Masanobu Mizoguchi, Kanagawa (JP); Shintaro Kumano, Hyogo (JP)

Correspondence Address: BIRCH STEWART KOLASCH & BIRCH, PO BOX 747, FALLS CHURCH, VA, 22040-0747, US

(21) Appl. No.: 10/914,191

(22) Filed: Aug. 10, 2004

(30) Foreign Application Priority Data
Feb. 12, 2003 (JP) 403681/2003

(51) Int. Cl. G06F 17/60

(52) U.S. Cl. 705/7

(57) ABSTRACT

In an aspect of the present invention, a facilities control system includes a simulation section which carries out a simulation of a time change of a status of an object of a target based on a status data showing the target status in the facilities by using a facilities model; and a display section which displays a simulation result. The facilities model includes a plurality of nodes, in each of which a process is carried out the target based on a first condition, which is set to the node to determine a throughput of the process in the node. A plurality of links, each of which connects between two of the plurality of nodes, and in each of which a process is carried out the target based on a second condition, which is set to the link to determine a throughput of the process in the link.

### BACKGROUND OF THE INVENTION

1. Field of the Invention

The present invention relates to a facilities control system and a method of controlling facilities, and more particularly to a facilities control system and a method of controlling facilities, in which an operation efficiency and safety of the facilities are improved.

2. Description of Related Art

A system for controlling facilities with various functions is known. For example, a system for controlling various functions of an airport is known. FIG. 1 is a block diagram showing an example of the conventional airport control system. The conventional airport control system is composed of a plurality of subsystems which operate independent each other. Most of the subsystems belong to companies, a government office, and groups. The respective subsystems are provided to have special functions and have equipments 122-1 to 1122-m1, 124-1 to 124-m2, 126-1 to 126-m3, and 128-1 to 128-m4 for the function and local databases 123, 125, 127, and 129. The subsystems are such as an apron control subsystem 112 for an apron of airplane, a flight data subsystem 114 for flight schedule of the airplane, a check-in subsystem 116 for check-in of passengers, a carrying baggage process subsystem 118 for baggages of the passengers. In the system shown in FIG. 1, cooperation among the subsystems is mainly carried out through contact between staffs using telephone lines 136.

FIG. 2 is a block diagram showing another example of the conventional airport control system. In this conventional system, the respective subsystems are connected with each other through a network 135. Then, those subsystems transmit predetermined data based on an occurring event to a central database 104 of an airport control apparatus 102 connected with the network 135. The airport control apparatus 102 delivers the data to preset ones of local databases based on a kind of the received data. In the system shown in FIG. 2, the data showing the event is automatically transmitted to the subsystems through the network 135. However, the above system does not carry out simulation and cannot predict a future situation based on a current status. Therefore, it is impossible to automatically cooperate the subsystems.

In conjunction with the above description, an airport baggage processing system is disclosed in Japanese Laid Open Patent Application (JP-P2002-302259A). In this conventional example, there are a plurality of baggage claim fields in an airport of an arrival country. Which of the plurality of baggage claim fields in the airport of the arrival country is used is specified by a computer in a departure country. The specified baggage claim field is notified to passengers when an airplane takes off. Data showing the specified baggage claim field is notified to through a network. In the airport of the arrival country, the baggages of the passengers are unloaded from the airplane and transported to the specified baggage claim field.

Also, an apron control system is disclosed in Japanese Laid Open Patent Application (JP-P2001-167154A). In this conventional example, when a delay of an airplane is larger than a threshold, a detection control unit of the apron adjustment system determines whether a delay is caused in another airplane to be connected with the airplane. When the connection delay is caused, the detection control unit carries out an apron overlap detection process and a curfew out-of-time detection process. In the apron overlap detection process, whether an apron use time of the connection airplane overlaps that of the other airplane is determined. In the curfew out-of-time detection process, whether the arrival time of the connection airplane to the arrival airport and the departure scheduled time of a next connection airplane after a curfew finish time is determined. When the apron overlap is determined, the effect that the apron use times overlap is notified to the arrival airport. When it is determined to be curfew out-of-time, the effect that the arrival time or the departure time becomes curfew out-of-time is notified to the arrival airport.

Also, a security control system is disclosed in Japanese Laid Open Patent Application (JP-P2001-306659A). In the system of this conventional example, a passenger leaves a baggage to traffic transportation. An ID data for identifying a passenger is recorded to a storage media such as an. IC card and an IC tag at the time of reception of the baggage and the storage media are carried with the baggage and the passenger. Also, the location of the passenger is managed by using a non-contact type communication device with the storage media.

### SUMMARY OF THE INVENTION

Therefore, an object of the present invention is to provide a facilities control system and a method of controlling facilities, in which facilities can be efficiently operated.

Also, another object of the present invention is to provide a facilities control system and a method of controlling facilities, in which a change in the status of facilities can be accurately estimated.

Also, another object of the present invention is to provide a facilities control system and a method of controlling facilities, in which it is possible to adequately measure to the change in the status of the facilities.

Also, another object of the present invention is to provide a facilities control system by which facilities whose efficient operation is possible can be designed.

Also, another object of the present invention is to provide a facilities control system in which the facilities can be designed such that the facilities is minimum and a manufacturing cost is restrained.

To provide the facilities control system and a method of controlling facilities, in which a safety in an airport is improved while any of the above objects of the present invention is achieved.

In an aspect of the present invention, a facilities control system includes a simulation section which carries out a simulation of a time change of a status of an object of a target based on a status data showing the target status in the facilities by using a facilities model; and a display section which displays a simulation result. The facilities model includes a plurality of nodes, in each of which a process is carried out the target based on a first condition, which is set to the node to determine a throughput of the process in the node. A plurality of links, each of which connects between two of the plurality of nodes, and in each of which a process is carried out the target based on a second condition, which is set to the link to determine a throughput of the process in the link.

Here, the simulation section carries out the simulation over all of a plurality of objects while the target is changed among the plurality of objects.

Also, the first condition set to at least one of the plurality of nodes may contain a function of time to indicate a time change of the throughput. Also, the first condition set to at least one of the plurality of nodes may contain a time stayed in the at least node. The second condition may contain a selection probability of one of the links connected with one of the plurality of nodes.

Also, the facilities control system may further include an evaluation section; and a countermeasure database storing countermeasures to an extraordinary situation. When the extraordinary situation occurs, the throughput of the process in a specific node of the plurality of nodes may be decreased in the simulation. The evaluation section may compare the statues of the objects and a first threshold, select one of the countermeasures when the statues of the objects is larger than the first threshold, display the selected countermeasure on the display section, and drive the simulation section again. In this case, when there are the countermeasures to the extraordinary situation, a priority level may be allocated to each of the countermeasures, and the evaluation section may select one of the countermeasures based on the priority levels.

Also, the facilities control system may further include a simulation database which stores a set of each of the plurality of nodes and the first condition and a set of each of the plurality of links and the second condition. The facilities model may be set based on a plurality of the processes to the target in the plurality of nodes and links of the facilities, and the simulation database.

Also, the facilities may be an airport. In this case, a plurality of the processes in the plurality of nodes and links is either of a set of processes when passengers as the targets board an airplane, a set of processes when a baggage of each passenger as the target is loaded into the airplane, a set of processes when the passengers as the targets get off an airplane, and a set of processes when the baggage of each passenger as the targets is unloaded into the airplane.

Also, the facilities control system may further include a model database storing the facilities mode and another facilities model; and an evaluation section. The evaluation section evaluates whether the throughput of the process in a specific node of the plurality of nodes is sufficient to the target based on the status of the target in a simulation result, and adds another facilities model when it is determined to be insufficient, and drives the simulation section again. The simulation section carries out the simulation by using the facilities model and another facilities model.

Also, the facilities may be an airport. In this case, the facilities control system further may include a flight schedule database storing flight data of departure and arrival airplanes and passengers and baggages of the departure and arrival airplanes, and a number of the objects is changed based on the flight data during the simulation.

In another aspect of the present invention, a method of controlling facilities is achieved by simulating a time change of a status of an object of a target based on a status data showing the target status in the facilities by using a facilities model; and by displaying a simulation result. The facilities model includes a plurality of nodes, in each of which a process is carried out the target based on a first condition, which is set to the node to determine a throughput of the process in the node and a plurality of links, each of which connects between two of the plurality of nodes, and in each of which a process is carried out the target based on a second condition, which is set to the link to determine a throughput of the process in the link.

Here, the simulating may be achieved by simulating over all of a plurality of the objects while the target is changed among the plurality of objects.

Also, the first condition set to at least one of the plurality of nodes may contain a function of time to indicate a time change of the throughput. Also, the first condition set to at least one of the plurality of nodes may contain a time stayed in the at least node. The second condition may contain a selection probability of one of the links connected with one of the plurality of nodes.

Also, the method may be achieved by further decreasing the throughput of the process in a specific node of the plurality of nodes in the simulation when an extraordinary situation occurs; by comparing the statues of the objects and a first threshold; by selecting one of countermeasures when the statues of the objects is larger than the first threshold; by displaying the selected countermeasure on the display section; and by driving the simulating step again. In this case, when there are the countermeasures to the extraordinary situation, a priority level may be allocated to each of the countermeasures. The selecting may be achieved by selecting one of the countermeasures based on the priority levels.

Also, the method may be achieved by further setting the facilities model based on a plurality of the processes to the target in the plurality of nodes and links of the facilities, and a simulation database which stores a set of each of the plurality of nodes and the first condition and a set of each of the plurality of links and the second condition.

Also, the facilities may be an airport. At this time, a plurality of the processes in the plurality of nodes and links is either of a set of processes when passengers as the targets board an airplane, a set of processes when baggages of the passengers as the targets is loaded into the airplane, a set of processes when the passengers as the targets get off an airplane, and a set of processes when baggages of the passengers as the targets is unloaded into the airplane.

Also, the method may be achieved by further evaluating whether the throughput of the process in a specific node of the plurality of nodes is sufficient to the target based on the status of the target in a simulation result; by reading and another facilities model from a simulation database and adding the another facilities model to the facilities model when it is determined to be insufficient; and by simulating the time change of the status of the target by using the facilities model and the another facilities mode.

Also, when the facilities is an airport, the method may be achieved by further changing a number of the objects during the simulation based on the flight data indicative of departure and arrival airplanes and passengers and baggages of the departure and arrival airplanes.

In another aspect of the present invention, a computer-executable software product for achieving the functions of: simulating a time change of a status of an object of a target based on a status data showing the target status in the facilities by using a facilities model; and displaying a simulation result. The facilities model may include a plurality of nodes, in each of which a process is carried out the target based on a first condition, which is set to the node to determine a throughput of the process in the node; and a plurality of links, each of which connects between two of the plurality of nodes, and in each of which a process is carried out the target based on a second condition, which is set to the link to determine a throughput of the process in the link.

Also, the function of simulating may include a function of simulating over all of a plurality of the objects while the target is changed among the plurality of objects.

### BRIEF DESCRIPTION OF THE DRAWINGS

FIG. 1 is a block diagram showing an example of a conventional airport control system;

FIG. 2 is a block diagram showing another example of the conventional airport control system;

FIG. 3 is a block diagram showing a facilities control system according to first to sixth embodiments of the present invention;

FIG. 4 is a table showing a data delivery database;

FIG. 5 is a table showing a flight schedule database;

FIG. 6 is a table showing a status database;

FIG. 7 is a table showing a capability database;

FIG. 8 is a table showing a quantity database;

FIG. 9 is a table showing a node setting database;

FIG. 10 is a table showing another node setting database;

FIG. 11 is a table showing a link setting database;

FIG. 12 is a table showing a countermeasure database;

FIG. 13 is a block diagram showing an example of a model of airport ground facilities;

FIG. 14 is a flow chart showing an operation of the facilities control system according to the first and second embodiments of the present invention;

FIG. 15 is a block diagram showing another example of the model of the airport ground facilities;

FIG. 16 is a flow chart showing an operation of the facilities control system according to the third and fourth embodiments of the present invention;

FIG. 17 is a block diagram showing another example of the model of the airport ground facilities;

FIG. 18 is a block diagram showing another example of the model of the airport ground facilities;

FIG. 19 is a block diagram showing another example of the model of the airport ground facilities;

FIG. 20 is a flow chart showing the operation of the facilities control system according to the fifth embodiment of the present invention;

FIG. 21 is a flow chart showing the operation of the facilities control system according to the sixth embodiment of the present invention;

FIG. 22 is a block diagram showing the configuration of the facilities control system according to a seventh embodiment of the present invention; and

FIG. 23 is a flow chart showing the operation of the facilities control system according to the seventh embodiment of the present invention.

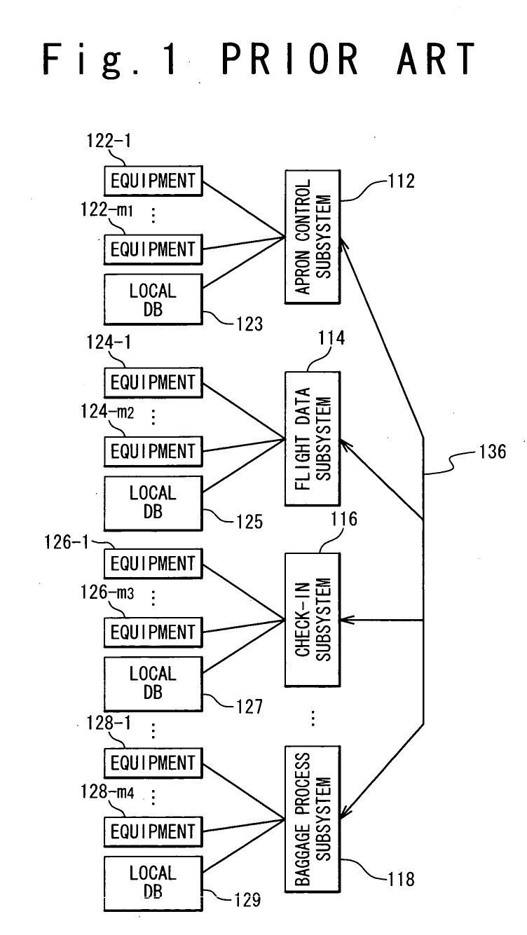

### DESCRIPTION OF THE PREFERRED EMBODIMENTS

Hereinafter, a facilities control system and a method of controlling facilities of the present invention will be described in detail with reference to the attached drawings.

In the following embodiments, the present invention will be described using an airport control system for international lines. However, the present invention is applicable to facilities which have a plurality of sections such as a ticket section, a check-in section, a carrying baggage inspection section and a gate section, or a first exhibition room, a second exhibition room, a recess section, a third exhibition room and an exhibition show room, and in which persons and articles flow in one way while stopping temporarily in each section, as in departure and arrival in a domestic line of an airport, embarkation and disembarkation in a harbor, and passage in a museum.

[First Embodiment]

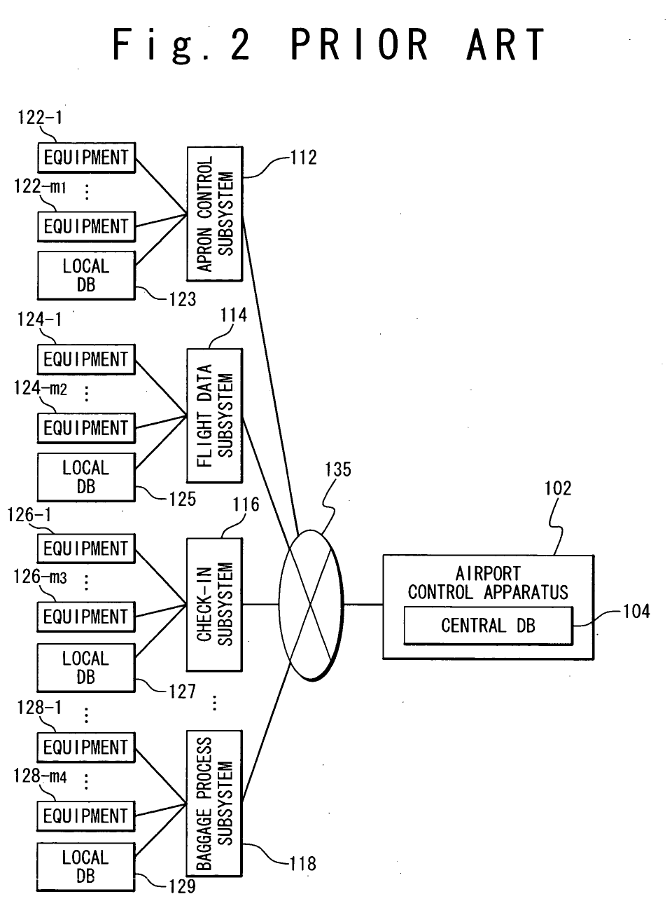

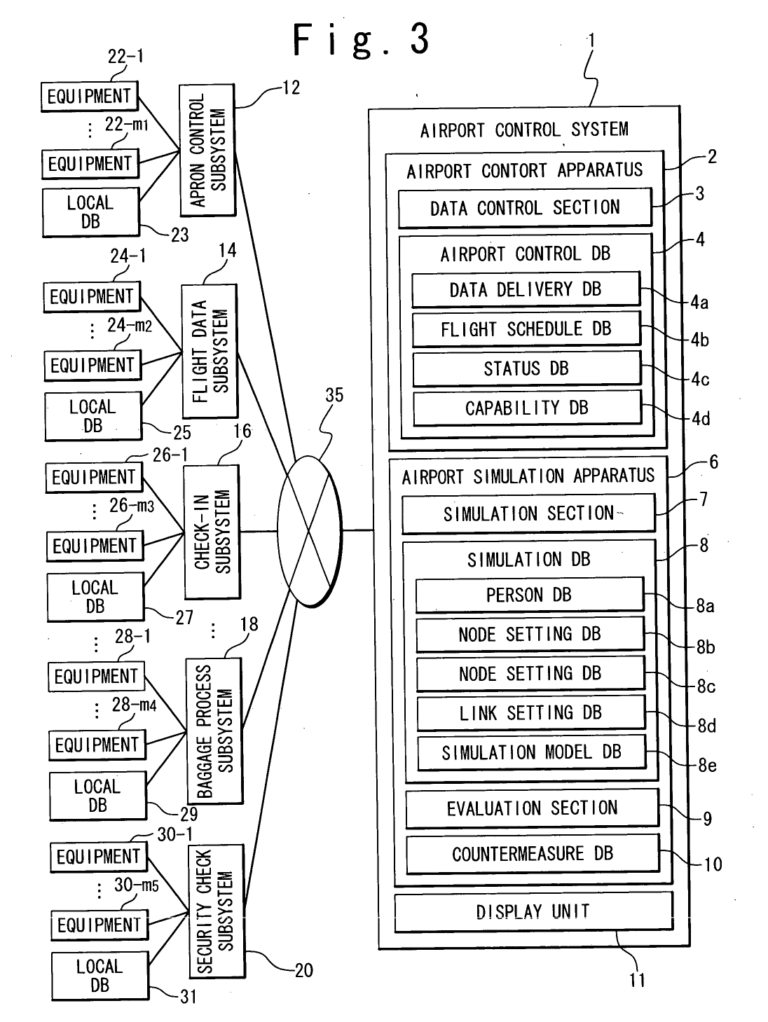

First, the facilities control system according to the first embodiment of the present invention will be described. FIG. 3 is a block diagram showing the configuration of an airport control system as the facilities control system according to the first embodiment of the present invention. The airport control system 1 is composed of an airport control apparatus 2, an airport simulation apparatus 6, and a display unit 11. The display unit 11 displays data supplied from the airport control apparatus 2 and the airport simulation apparatus 6. The airport control system 1 is connected with a plurality of subsystems 12 to 20 through a network 35. The subsystems 12 to 18 are same as the subsystems 112 to 118 shown in FIG. 2. In the present invention, a security control subsystem 20 is further provided and is composed of equipments 30-1 to 30-m5 and a local database 31. The network 35 is a network in the airport but the airport control system 1 can use data received from external subsystems through a private line network or a public line network like the Internet.

The airport control apparatus 2 is a data processing unit such as a work station. The airport control apparatus 2 is composed of a data control section 3 realized based on a program and an airport control database (DB) 4 realized based on data and a program for processing the data. The data control section 3 acquires predetermined data from each subsystem through the network 35 in response to an event and stores in the airport control database 4. Also, the data control section 3 delivers the acquired data to predetermined local databases based on a kind of the acquired data and a data delivery database 4a to be described later. The airport control database 4 contains the data delivery database 4a, a flight schedule database 4b, a status database 4c, and a capability database 4d.

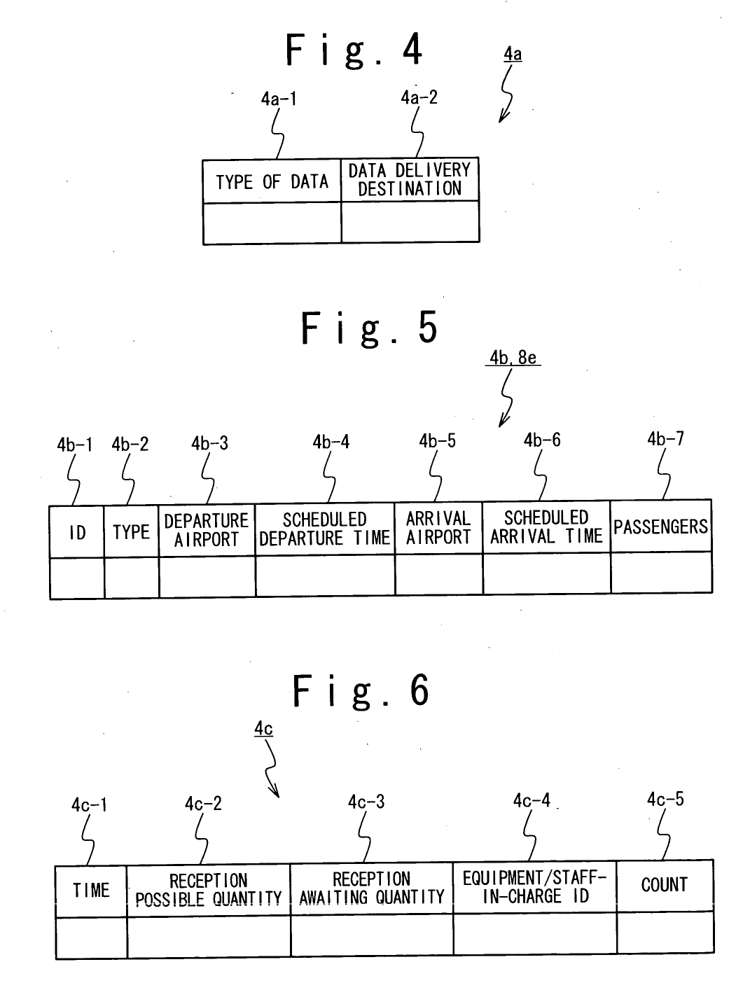

FIG. 4 is a table showing the data delivery database 4a. The data delivery database 4a stores a set of a kind 4a-1 of data acquired from each subsystem and a data delivery destination 4a-2 for the acquired data to be delivered. The kind 4a-1 of the data is such as the number of persons processed by a subsystem, the number of passengers of each airplane, delay and cancellation of flight of the airplane, and occurrence of trouble in any of the facilities. The data delivery destination 4a-2 is preset for every subsystem. The data delivery destination 4a-2 is stored as an ID of each subsystem.

FIG. 5 is a table showing the flight schedule database 4b. The flight schedule database 4b stores a set of an identification number 4b-1 for identifying a flight and detailed data of the flight. The detailed data of the flight is a type 4b-2 of an airplane, a departure airport 4b-3, a departure scheduled time 4b-4, an arrival airport 4b-5, an arrival scheduled time 4b-6 and the number of passengers 4b-7. The detailed data of the flight is set by each airway.

FIG. 6 is a table showing the status database 4c. The status database 4c stores a set of a time 4c-1 and statuses of staffs and equipments associated with each of processes in the airport at the time 4c-1. The time 4c-1 is a time when data is received. The statuses of staffs and equipments are such as a reception possible quantity 4c-2, a reception awaiting quantity 4c-3, an equipment/staff-in-charge ID 4c-4, and a count of equipments or staffs 4c-5. The reception possible quantity 4c-2 is a quantity of the persons or baggages that it is possible to receive in a process. The reception awaiting quantity 4c-3 is a quantity of the persons or baggages actually awaiting the reception of the process. The reception awaiting quantity 4c-3 is detected by a sensor and so on. The equipment/staff-in-charge ID 4c-4 is an ID for specifying an equipment or a staff in charge to the process. The count of equipments or staffs 4c-5 is the number of stands or the number of staffs actually working or operating for the process. These data are transmitted from the equipment for the process via a relating subsystem.

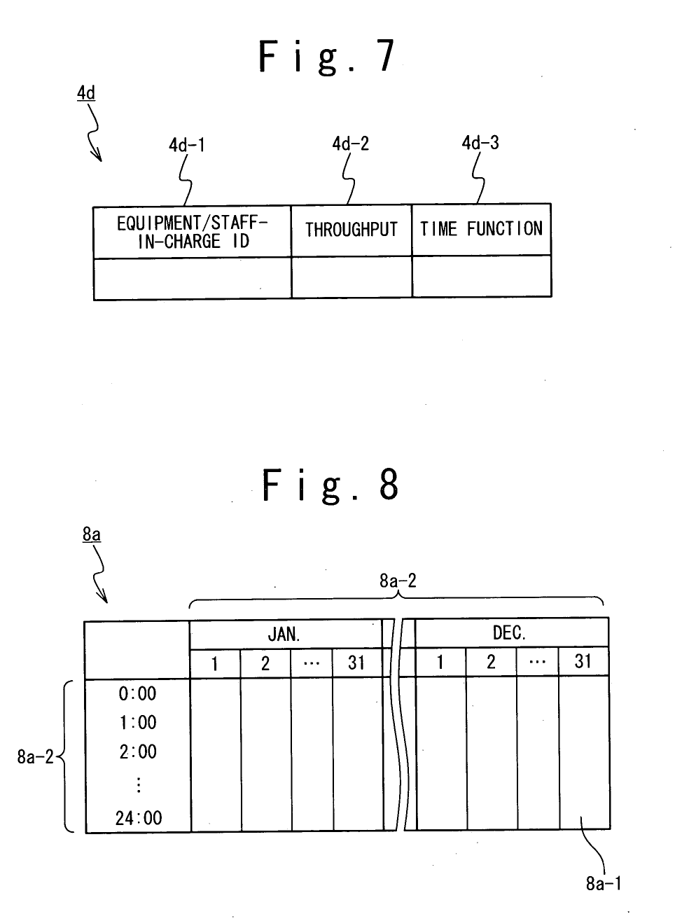

FIG. 7 is a table showing the capability database 4d. The capability database 4d stores a set of an equipment/staff-in-charge ID 4d-1, a capability of the equipment/staff-in-charge. The capability of the equipment/staff-in-charge is expressed by a throughput 4d-2 and a time function 4d-3. The equipment/staff-in-charge ID 4d-1 is the same as the equipment/staff-in-charge ID 4c-4. The throughput 4d-2 is a throughput of the equipment or staff in charge per a unit time. For example, the throughput 4d-2 is expressed as ×/min. The time function 4d-3 is a function of time to show the decrease of the throughput of the staff in charge with the elapsed time. By preparing the throughput 4d-2 and the time function 4d-3, the capability of the actual equipment and staff in charge to the process (fatigue of the staff and the capability of the staff in charge) can be expressed.

Referring to FIG. 3, the airport simulation apparatus 6 is a data processing unit such as a work station. The airport simulation apparatus 6 is composed of a simulation section 7, an evaluation section 9, a simulation database 8 storing data and executing a program for the data, and a countermeasure database 10.

The simulation section 7 simulates a temporal flow of a target for every person (passenger) or for every baggage based on status data showing change of the person or baggage in position, i.e., movement by using an airport model showing a hardware configuration, an operation flow and a software configuration. Thus, the simulation section 7 simulates the congestion of persons or baggages left without being processed or transported, and the time change of the congestion and estimates future status data after several hours. Also, it is possible to simulate under assumption that the persons or baggages are fluid or fine particles. In such a case, the simulation is possible by applying the present invention to a simulator for fluid and the fine particles.

The evaluation section 9 detects a problem of the airport operation based on the future status data. A countermeasure for the estimated situation is selected. A situation after the countermeasure is applied is simulated by the simulation section 7 and the effectiveness of the countermeasure is verified. If there is not a problem, the evaluation section 9 outputs the countermeasure to the subsystems relating to the countermeasure.

The simulation database 8 contains a quantity database 8a, a node setting database 8b, a node setting database 8c, a link setting database 8d, and a simulation model database 8e.

FIG. 8 is a table showing the quantity database 8a. The quantity database 8a stores a set of each annual time 8a-2 and a quantity data showing the number of persons or baggages 8a-1 entering the airport at the time 8a-2. The quantity data 8a-1 is provided for each of the number of passengers of departure flights, the number of passengers of arrival flights, the number of baggages brought by the passengers of departure flights, and the number of baggages brought by the passengers of arrival flights. These values are estimated based on the results of the last year and the departure flights and the arrival flights of the flight schedule database 4b, and the reservation situation.

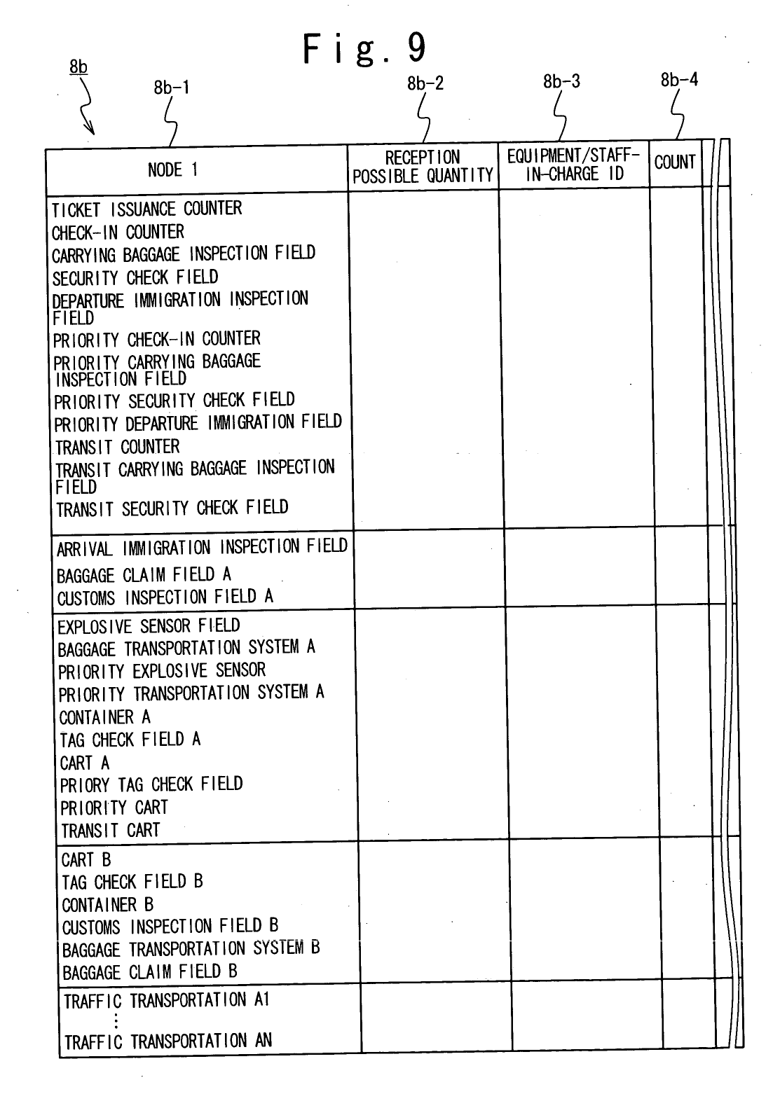

FIG. 9 is a table showing node setting database 8b. The node setting database 8b stores a set of a node 8b-1 and the capability of the node. The node 8b-1 is a field where a predetermined process is carried out to the passenger and the baggage. The node 8b-1 is such as a check-in counter and a security check field. The capability (first condition) is a reception possible quantity 8b-2, an equipment/staff-in-charge ID 8b-3, and a count of equipments or staffs 8b-4. The capability 8b-2 is a maximum number of persons or baggages acceptable at once in the node. The equipment/staff-in-charge ID 8b-3 is an ID for specifying the equipment or staff in charge in the node 8b-1. This is related to the throughput 4d-2 showing the throughput of the equipment/staff-in-charge for every unit time via the equipment/staff-in-charge ID 4d-1 of the capability database 4d. The count of equipments or staffs 8d-4 is the number of equipments or the number of staffs actually working or operating for the process. These values are set based on the actual equipments and staffs like the status database 4c of FIG. 6 and the capability database 4d of FIG. 7.

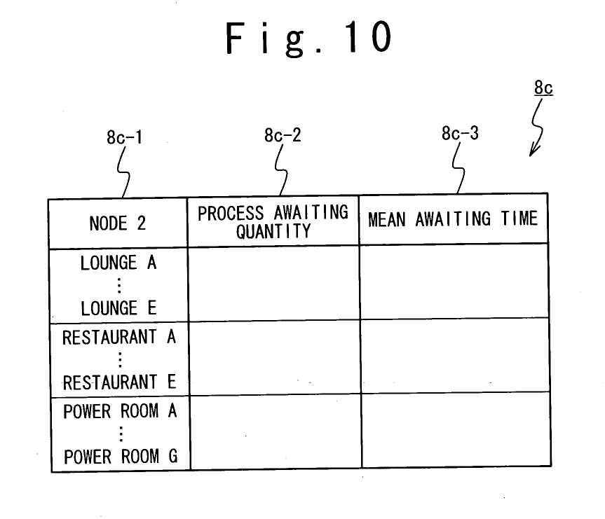

FIG. 10 is a table showing the node setting database 8c. The node setting database 8c stores a set of a node 8c-1 and a capability. The node 8c-1 is a field where a predetermined process is carried out to the passengers. The nodes are such as a lounge, a powder room, a telephone box, a restaurant, and a shop. The capability (the first condition) is a process awaiting quantity 8c-2, a mean awaiting time 8c-3. The process awaiting quantity 8c-2 is a maximum quantity of passengers and baggages awaiting a process. The mean awaiting time 8c-3 is an average time that the passengers or baggages are processed in the node 8c-1. Here, they depend on the departure of an airplane in the boarding gate. These values are set based on the actual facilities (containing persons) like the status database 4c of FIG. 6 and the capability database 4d of FIG. 7.

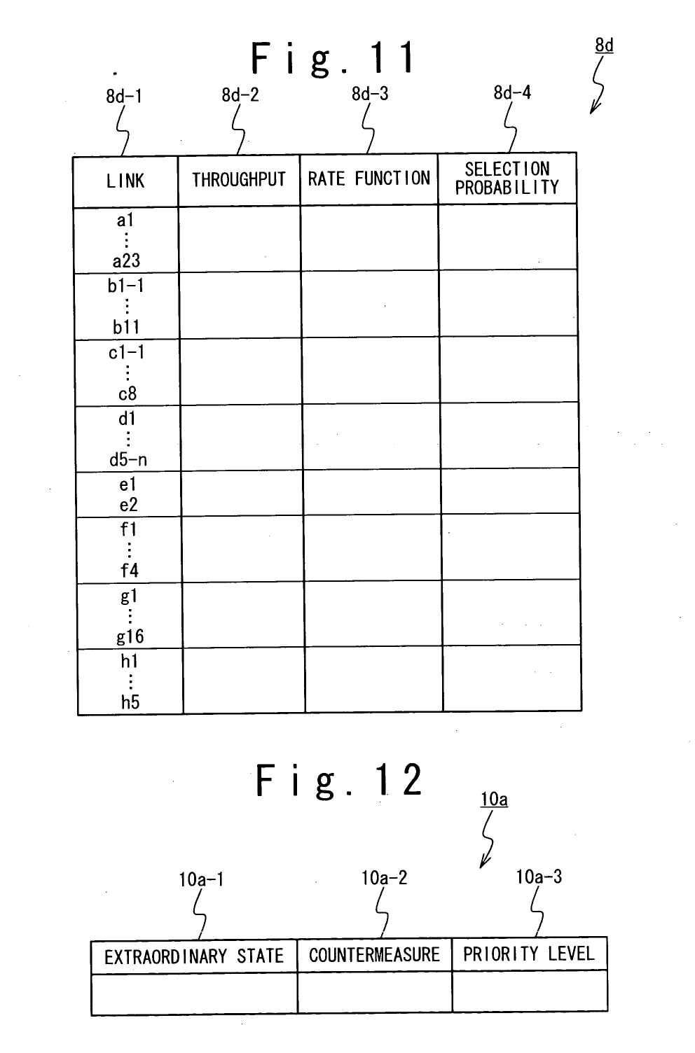

FIG. 11 is a table showing the link setting database 8d. The link setting database 8d stores a set of a link 8d-1 and a capability. The link 8d-1 is a route linking the nodes (8b-1, 8c-1) and shows a route through which the passengers and the baggages move. The link 8d-1 is such as a passage, a stair, people mover, a moving walkway, and a conveyor. In the table, they are shown by symbols ak, bk, ck, dk, ek, fk. The capability (the second condition) is composed of a processing speed 8d-2, a speed function 8d-3, and a selection probability 8d-4. The processing speed 8d-2 is the number of persons or baggages to be transported by the link 8d-1 for every unit time. The speed function 8d-3 is a function to correct the processing speed 8d-2 of passengers or baggages to an actual processing speed distribution. For example, even if a moving walkway moves in a constant speed, there are persons who walk on the moving walkway, and persons who do not walk. In the same way, even if a transportation capability is constant, the speed of the transportation is different depending on the size and weight of the baggage. Therefore, the function adjusts the processing speed such that a processing speed distribution of the passengers or baggages is a normal distribution in which the most frequent value is the processing speed 8d-2. In this way, the element of the capability of the passenger and the element of the capability of the equipment in the link can be expressed. The selection probability 8d-4 is a probability that each link is selected when a plurality of links are connected to the node. For example, when it is possible to select one of three fields of a restaurant, a power room, and a next process field, the selection probability 8d-4 indicates a probability that each of the three fields is selected. These values are set based on the status database 4c of FIG. 6 and the statistics of the actual facilities.

FIG. 12 is a table showing a countermeasure database 10. The countermeasure database 10 stores a set of an extraordinary state 10a-1, a countermeasure 10a-2, and a priority 10a-3. The extraordinary state 10a-1 is an extraordinary situation estimated by the simulation or a previously assumed extraordinary situation. For example, it is the occurrence of a congestion of the passengers or baggages in an area. The countermeasure is the countermeasure 10a-2 and the priority 10a-3. The countermeasure 10a-2 is a countermeasure to cope with such a situation. For example, when it is estimated that the passengers is crowed in an area, the number of equipments or staffs are increased or present equipments or staffs are changed to new equipments or staffs which a high capability or throughput. The priority 10a-3 shows priority level when a plurality of countermeasure 10a-2 are present.

Referring to FIG. 3, there are the apron control subsystem 12, the flight data subsystem 14, the check-in subsystem 16, the baggage process subsystem 18, and the safety control system 20 as the subsystems. They are data processing units such as work stations. These are connected with each other through the network 35 in the airport, but may be connoted via external networks such as public and private lines, and the Internet.

The apron control subsystem 12 controls equipments 22-1 to 22-m1 and a local database 23 and manages the apron of the airport. The equipments 22-1 to 22-m1 are equipments, sensors, and facilities which relate to the control of the apron. The flight data subsystem 14 controls equipments 24-1 to 24-m2 and a local database 25 and manages the flight schedule of airplanes. The equipments 24-1 to 24-m2 are equipments, sensor, and facilities which relate to the flight schedule of the airplanes. The check-in subsystem 16 controls equipments 26-1 to 26-m3 and a local database 27 and manages the check-in procedure of the passengers. The equipments 26-1 to 26-m3 are equipments, sensors, and facilities which relate to the check-in procedure of the passengers. The baggage process subsystem 18 controls equipments 28-1 to 28-m4 and a local database 29 and manages the baggages of the passengers. The equipments 28-1 to 28-m4 are equipments, sensors, and facilities which relate to the baggages of the passengers. The safety control subsystem 20 controls equipments 30-1 to 30-m4 and a local database 31 and manages the safety of the airport. The equipments 30-1 to 30-m4 are equipments, sensors, and facilities which relate to the safety of the airport. The equipments and facilities shown with the above-mentioned node and link contain each equipment in each subsystem. Data from each equipment is stored in the airport control database 4 and is used by the airport simulation apparatus 6 according to the necessity.

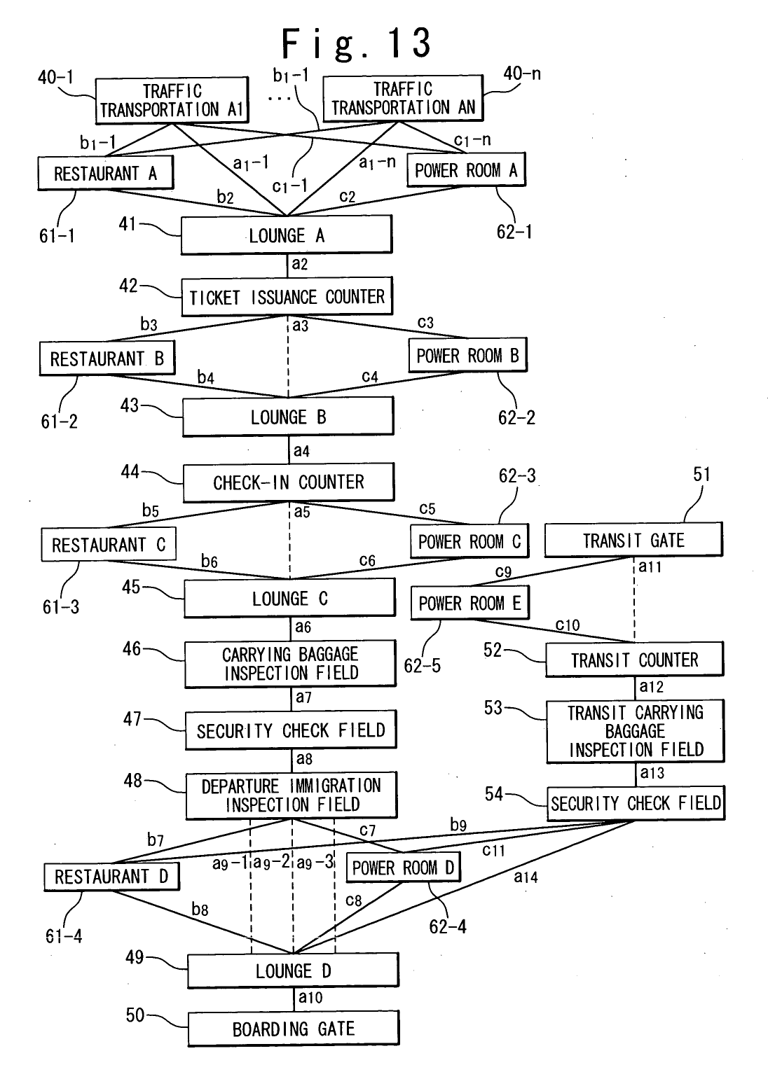

FIG. 13 is a block diagram showing an example of a model of the airport ground facilities. In the model of FIG. 13, processes are modeled when the passengers who got off from transportation boards into an airplane or the passengers who got off from an airplane boards into a connection airplane through a boarding gate. Although there are a plurality of boarding gates, only one boarding gate is shown for avoiding complex in the figure. Such an airport model is stored in the simulation model database 8e of the airport simulation apparatus 6. This model is set based on the arrangement of each process and each equipment in an actual airport. However, it is possible to set virtually.

As nodes (corresponding to 8b-1 and 8c-1), there are a lounge A41, a ticket issuing counter 42, a lounge B43, a check-in counter 44, a lounge C45, a carrying baggage checking counter 46, a security check 47, a departure immigration inspection 48, a lounge D49, a transit counter 52, a transfer baggage examination 53, a transit security check 54, restaurants A61-1 to D61-4, and powder rooms A62-1 to E62-5. On the other hand, as links (corresponding to 8d-1), there are main passages a1-1 to a1-n and a2 to a14, sub passages b1-l to b1-n, b2 to b9, c1-1 to c1-n, and c2 to c1. When this model is used for a simulation, the data stored in the node setting database 8b, the node setting database 8c, and the link setting database 8d of the simulation database 8 are used as the capabilities (throughputs) of each node and each link.

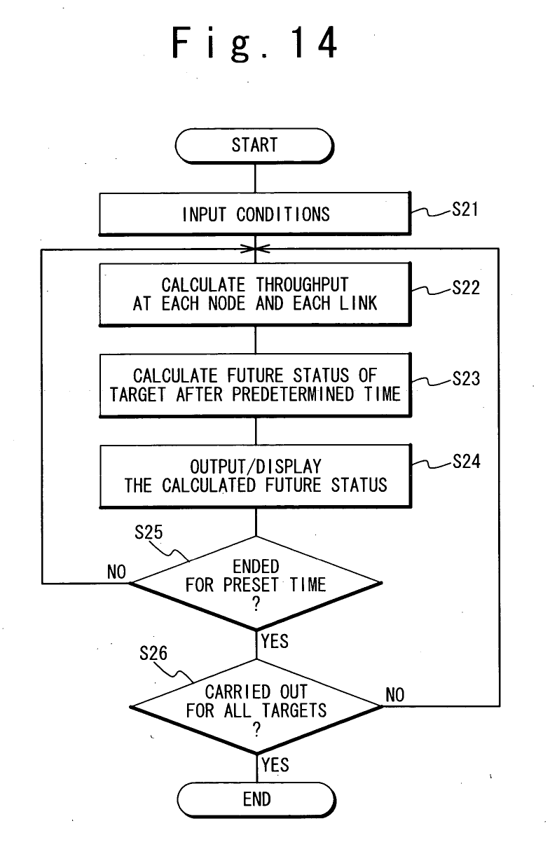

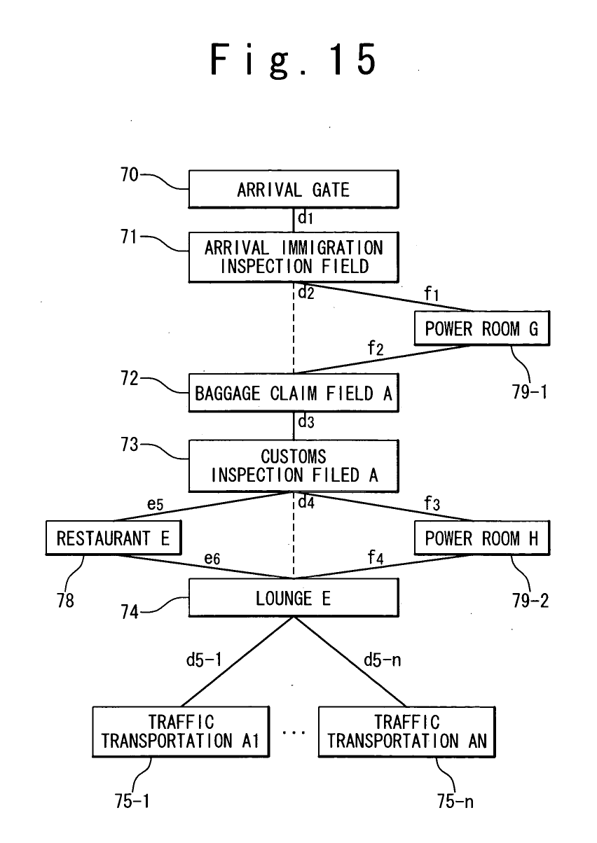

Next, an operation of the facilities control system according to the first embodiment of the present invention will be described with reference to the attached drawings. FIG. 14 is a flow chart showing an operation of the facilities control system according to the first embodiment of the present invention. Here, a case will be described where the airport model of FIG. 13 corresponds to an actual airport and the simulation is carried out to estimate a future status of the airport based on a current status of the airport. Here, the departure from an international line is used as an example of the simulation. In this simulation, a temporal flow of each of objects such as passengers and baggages is simulated based on the status data.

(1) Step S21

The simulation section 7 reads out an airport model (FIG. 13) from the simulation model database 8e. Also, the simulation section 7 acquires the status data showing the current status of passengers and baggages at each node and each link in the airport from the status database 4c of FIG. 6 and the capability database 4d of FIG. 7. In this case, if virtual data is inputted, a virtual future status can be estimated.

(2) Step S22

The simulation section 7 calculates an actual throughput at a current time at each node and each link in the airport. The calculation of the actual throughput of the node will be described, by using the check-in counter 44 as an example.

First, the equipment/staff-in-charge ID 4c-4 operating at the current time in the check-in counter 44 is acquired from the status database 4c. Subsequently, the throughput 4d-2 and the time function 4b-3 of the equipment/staff-in-charge ID 4d-1 corresponding to the equipment/staff-in-charge ID 4c-4 are acquired from the capability database 4d. The actual throughput is calculated from an equation of throughput 4d-2×time function 4b-3 (example: 0.5×f(t) persons/min., where f(t) is a function with respect to elapsed time t). In this case, evaluation with a higher precision can be carried out in accordance with the capability of a staff in charge, and the throughput contains a throughput of the staff in charge in addition to the throughput of the equipment. Moreover, further practical evaluation can be carried out because the change of capability with respect to time is contained as the time function.

The calculation of the actual throughput of the link will be described, using a passage after the procedure of the check-in counter 44 as an example. After the procedure of the check-in counter 44, the passenger goes to either of the following sections: the passage a5, the passage b5, and the passage c5. Therefore, the actual throughput of each passage is calculated. First, the processing speed 8d-2 and the speed function 8d-3 of each passage are acquired from the link setting database 8d. Subsequently, the actual throughput (m/sec.) is calculated from an equation of processing speed 8d-2×speed function 8d-3. In this case, because a deviation of passengers is contained in the function in addition to the throughput of the passage (the transportation capacity), evaluation with higher precision can be carried out. Also, which of the passages is used is set based on the selection probability 8d-4 of the node setting database 8c. Because the probability of the selection of the passage is introduced, the evaluation with higher precision can be carried out.

(3) Step S23

The status data showing the status of a target such as a passenger or baggage after a predetermined time is calculated. The predetermined time depends on the data processing capability of the apparatus and is 0.5 sec., for example.

When there are the targets aligned in a line before the check-in counter 44 of FIG. 13, a virtual process is carried out for the predetermined time in the check-in counter 44. At this time, if the target stands in the line behind passengers of the number calculated based on the actual throughput×the predetermined time, the target positions in the line after the predetermined time. If the target stands in the line before the passengers of the number calculated, the target is during the check-in procedure before the check-in counter 44 or ends the check-in procedure and goes toward either of the following sections (passage a5, passage b5, and passage c5 or restaurant C61-3, powder room C62-3 and lounge C45). Which of the sections the target goes toward is set based on the selection probability 8d-4 of the node setting database 8c. That is, whether the check-in procedure in the check-in counter 44 is ended or is being carried out can be calculated based on the predetermined time. If the target selects the passage a5, it is possible to calculate whether the target is on the way of the passage a5 or reaches the lounge C45 based on the predetermined time and the actual throughput of the passage a5.

(4) Step S24

The simulation section 7 outputs and stores the simulation result (the status data of the target) in a predetermined storage section (not shown). In accordance with the setting, the simulation result is displayed on the display unit 11. That is, the simulation is carried out every predetermined time and the simulation result is displayed.

(5) Step S25

Whether the simulation at the above steps S21 to S24 is carried out every predetermined time for a preset time (>predetermined time) is determined. When it is determined that the simulation is not carried out for the preset time, the control flow returns to the step S21. When it is determined that the simulation is not carried out for the preset time, the control flow advances to a step S26.

(6) Step S26

Whether the simulation of the above steps S21 to S25 is carried out to all the passengers in the airport while changing the target is determined. In this case, when the target arrives in the airport one after another from outside, these passengers who arrives in the airport for the preset time are contained in the targets. When the simulation is not carried out to all the passengers, the control flow returns to the step S21. When the simulation is carried out to all the passengers, the control flow ends. It should be noted that the number of passengers who enters the airport newly for the preset time is estimated from the quantity database 8a and is used for the simulation.

In the present invention, the movement of each target is simulated every predetermined time for the preset time. The movement of all the targets in the airport for the preset time can be simulated. Thus, the status of the airport after the preset time can be accurately grasped.

The evaluation with higher precision can be carried out to correspond to the actual situation because the capability (throughput 4d-2, time function 4b-3) of each of staffs in charge and equipments in each node is contained in the present invention. Also, the evaluation with higher precision can be carried out to correspond to the actual situation because a deviation in the movement of the target in each link is contained as the data (speed function 8d-3, selection probability 8d-4). This embodiment can be applied in the same way even if the object is the baggage.

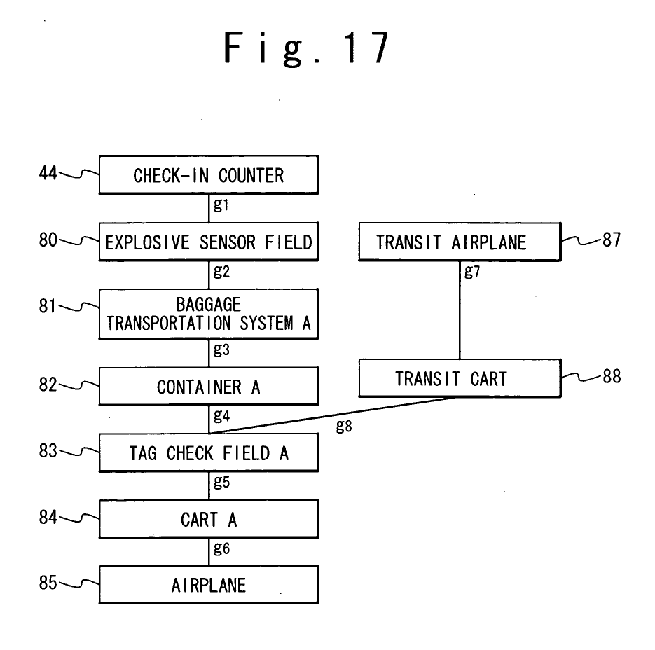

FIG. 17 is a block diagram showing another example of the model of the airport ground facilities. In the model of FIG. 17, processes that baggages of the passengers left in the check-in counter or the baggages of the transit passenger are loaded into an airplane. Such a model is stored in the simulation model database 8e of the airport simulation apparatus 6. This model is set based on the arrangement of each process and each equipment in the actual airport. However, it is possible to set it virtually. The simulation of the movement of the baggage to be loaded in the airplane becomes possible by using the airport model.

As the nodes (corresponding to 8b-1 and 8c-1), there are the check-in counter 44, an explosive sensor field 80, a baggage transporting system A 81, a container A 82, a tag checking Field A 83, a transportation cart A 4, a transit transportation cart 88. On the other hand, as the links (corresponding to 8d-1), there are main transportation passages g1 to g6, and sub transportation passages g7 to g8. As the capability of each of nodes and links, the data stored in the node setting database 8b, the node setting database 8c, and the link setting database 8d of the simulation database 8 are used. The movement of the baggages unloaded from the arrival airplane can be simulated by using the airport model. In this case, the airport model is the same as that shown in FIG. 17. The method of simulation is the same as that of the first embodiment, excluding that the object is the baggage of the passenger. Therefore, the same effect as in the first embodiment can be achieved.

[Second Embodiment]

The facilities control system according to the second embodiment of the present invention will be described below. FIG. 3 is a block diagram showing the configuration of the facilities control system according to the second embodiment of the present invention. Because the airport control system 1 is the same as in the first embodiment, the description of the airport control system 1 will be omitted.

FIG. 15 is a block diagram showing another example of the model of the airport ground facilities. In the model of FIG. 15, processes are modeled that the passengers get off the arrived airplane and get on transportations through the arrival gate. Such a model is stored in the simulation model database 8e of the airport simulation apparatus 6. This model is set based on the arrangement of each process and each equipment in an actual airport. However, it is possible to set it virtually. The movement of the passengers from the arrived airplane can be simulated by using the airport model.

As the nodes (corresponding to 8b-1 and 8c-1), there are an arrival immigration inspection field 71, a baggage claim field 72, a customs inspection field A73, a lounge E74, a restaurant E78, and powder rooms G79-1 to H79-2. On the other hand, as the links (corresponding to 8d-1), there are main passages d1 to d4, and d5-1 to d5-n, and subpassages f1 to f4 and e1 to e2. As the capability of each of nodes and links, the data stored in the node setting database 8b, the node setting database 8c, the link setting database 8d of the simulation data base 8 are used.

The operation of the facilities control system according to the second embodiment of the present invention is the same as that of the first embodiment, excluding that the airport model has the configuration shown in FIG. 15. Therefore, the description of the operation is omitted. In this embodiment, the same effect as in the first embodiment can be achieved in case of the “arrival”. That is, the facilities control system of the present invention can handle both of the “departure” case and “arrival” case. This embodiment can be applied in the same way even if the object is baggage.

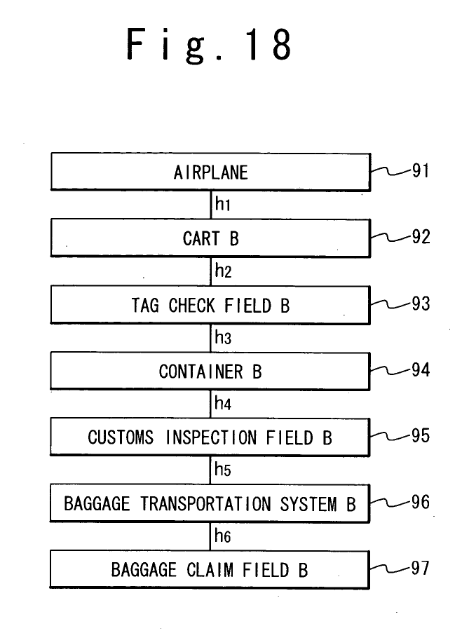

FIG. 18 is a block diagram of another example of the model of the airport ground facilities. In the model of FIG. 18, processes are modeled that the baggage is unloaded from an airplane and is handed over to the passenger. Such a model is stored in the simulation model database 8e of the airport simulation apparatus 6. This model is set based on the arrangement of each process and each equipment in the actual airport. However, it is possible to set it virtually.

As the nodes (corresponding to 8b-1 and 8c-1), there are a transportation cart B92, a tag checking filed B93, a container B94, a customs inspection field B95, a baggage transportation system B96, and a baggage claim field B97. On the other hand, as the link (corresponding to 8d-1), there are main transportation passages h1 to h6. As the capability of each of nodes and links, the data stored in the node setting database 8b, the node setting database 8c, and the link setting database 8d of the simulation database 8 are used. In this case, the airport model is the same as that of the second embodiment, excluding that the object is baggage. The airport model is one shown in FIG. 18. Therefore, the same effect as in the second embodiment can be achieved.

[Third Embodiment]

The facilities control system according to the third embodiment of the present invention will be described below. FIG. 3 is a block diagram showing the configuration of the facilities control system according to the third embodiment of the present invention. Because the airport control system 1 is the same as that of the first embodiment, the description is omitted. FIG. 13 is a block diagram showing an example of the model of the airport ground facilities. Because this airport model is the same as that of the first embodiment, the description is omitted.

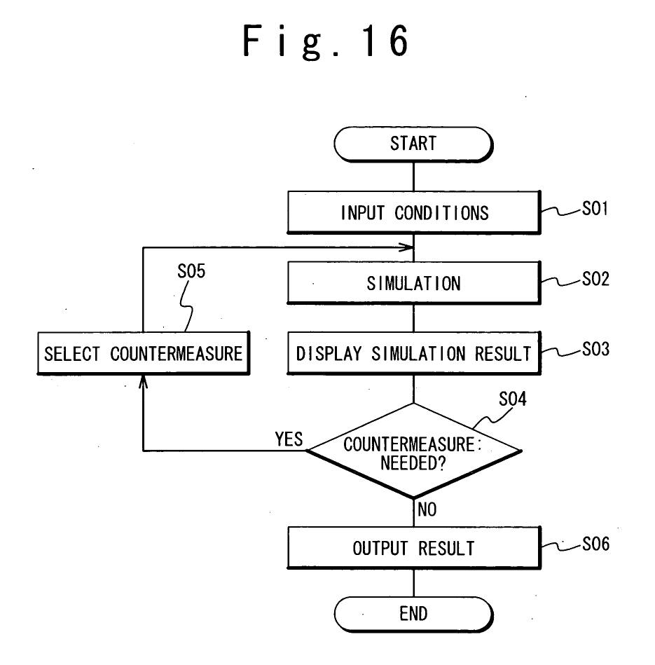

Next, an operation of the facilities control system according to the third embodiment of the present invention will be described below. FIG. 16 is a flow chart showing the operation of the facilities control system according to the third embodiment of the present invention. A simulation and proposal of a measurement will be described when the airport model of FIG. 13 corresponds to an actual airport and when a special situation occurs or is predicted to occur. Here, the simulation about the departure from an international line is used as an example. In this simulation, a temporal flow of every target (a target passenger or a target baggage) is simulated based on the status data.

(1) Step S01

The simulation section 7 reads out an airport model (FIG. 13) from the simulation model database 8e. Also, the simulation section 7 acquires the status data showing the current status of the target at each of nodes and links in the airport, from the status database 4c of FIG. 6 and the capability database 4d of FIG. 7. In addition, a condition indicative a special situation when the special situation occurs or is predicted to occur is inputted as a part of the status data. The situation is a situation that security in the airport is strengthened, or a situation that takeoff and landing of the airplane is limited because of weather. When the security in the airport is strengthened, it is predicted that an actual throughput per a unit time decreases because of request to show an identification card in the check-in counter 44, strict inspection in the carrying baggage inspection 46 and the security check 47. In this case, a predetermined coefficient is set in accordance with a degree of the security. In the calculation of the actual throughput, the predetermined coefficient is multiplied with usual throughput to decrease the actual throughput. However, if a virtual data is inputted, a virtual future status can be estimated.

(2) Step S02

The simulation section 7 carries out the simulation of the time change of the status data by using the airport model and the status data. The simulation is carried out for a desired time period. That is, the status data showing a state of the target at each of nodes and links in the airport after the predetermined time period is calculated. This simulation is the same as in the first embodiment.

(3) Step S03

The simulation section 7 displays the status data indicative of a future status after the predetermined time period on the display unit 11 and stores in the predetermined storage section (not shown). Also, the simulation section 7 outputs the status data to the evaluation section 9.

(4) Step S04

The evaluation section 9 compares the simulated status of the target at each of nodes and links and an extraordinary situation (the third condition) 10a-1. When the extraordinary situation 10a-1 occurs, the control flow advances to a step S05. For example, when the security level at the airport is strengthened, a congestion of the target passengers occurs in the carrying baggage inspection field 46 and the security check inspection field 47. In the present invention, it is possible to grasp the increase of the targets with the time in the carrying baggage inspection field 46 and the security check inspection field 47, through the simulation and the estimation based on numerical equations. The occurrence of the congestion can be determined based on whether the targets exceed the reception possible quantity 8b-2 of the node setting database 8b. When the congestion does not occur at each node and each link, the control flow advances to a step S06.

(5) Step S05

The evaluation section 9 selects the countermeasure 10a-2 corresponding to the extraordinary situation 10a-1 based on a priority level 10a-3. The settings of each node and each link of the airport model are changed based on the countermeasure 10a-2. The countermeasure 10a-2 is to increase the number of operating equipments in the carrying baggage inspection field 46 and the security check inspection field 47 when the extraordinary situation 10a-1 is occurrence of the congestion in the carrying baggage inspection field 46 and the security check inspection field 47. After the countermeasure 10a-2 is applied, the simulation is carried out once again at the step S02. It should be noted that the countermeasure may be inputted from outside.

(6) Step S06

When the simulation for the countermeasure is not carried out, a data indicative of no problem in the current situation is outputted. The data is displayed on the display unit 11. In this case, it is possible to determine that there is no problem in the current situation even if the special situation occurs. When the simulation for the countermeasure is carried out, the countermeasure 10a-2 and a data indicating that there is no problem in the countermeasure 10a-2 are outputted. These data are displayed on the display unit 11. Also, the countermeasure 10a-2 is outputted to the relating subsystems. In the above example, an instruction is outputted to the safety control subsystem 20 to increase the number of operation equipments for the carrying baggage inspection 46 and the security check inspection 47.

Through the above processes, it becomes possible to estimate what extraordinary situation occurs, immediately after a special situation, i.e., the current situation or the virtual situation occurs in the airport. In addition, it becomes possible to instruct how to measure to the extraordinary situation and prevent occurrence of the extraordinary situation.

This embodiment may be applied in the same way even if the object is baggage. For example, the same effect as in the third embodiment can be achieved even if the airport model is FIG. 17 and the target is baggage (the baggage of the passenger and the cargo).

[Fourth Embodiment]

The facilities control system according to the fourth embodiment of the present invention will be described below. FIG. 3 is a block diagram showing the configuration of the facilities control system according to the fourth embodiment of the present invention. Because the airport control system 1 is the same as that of the first embodiment, the description is omitted. FIG. 15 is a block diagram showing an example of the model of the airport ground facilities. Because this airport model is the same as in the second embodiment, the description is omitted. An operation of the facilities control system according to the fourth embodiment of the present invention is same as in the third embodiment excluding that the airport model is shown in FIG. 15. Therefore, the description is omitted. In this embodiment, the same effect as in the third embodiment can be achieved in case of the “arrival”. That is, the same method can be applied to both of the “departure” and “arrival”. This embodiment can be applied in the same way even if the target is the baggage. For example, the same effect as in the fourth embodiment can be achieved even if the airport model is FIG. 18 and the object is baggage (the baggage of the passenger and the cargo).

[Fifth Embodiment]

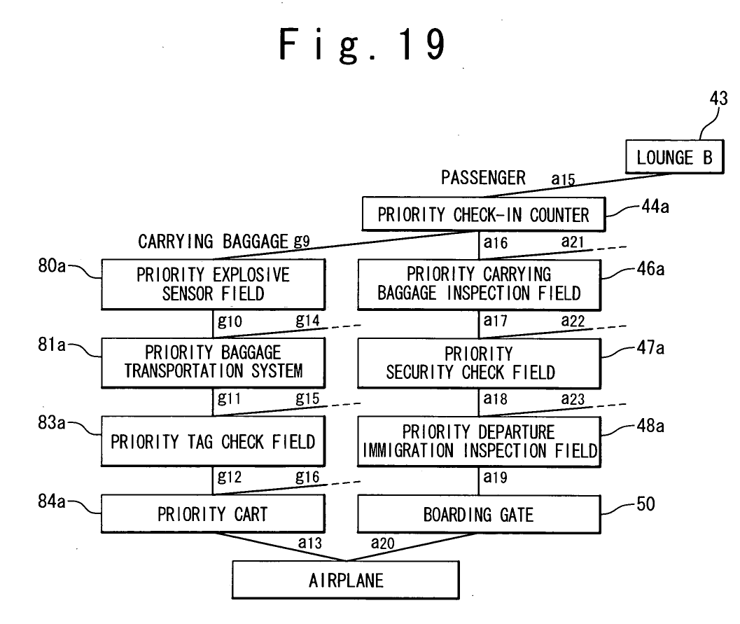

The facilities control system according to the fifth embodiment of the present invention will be described below. FIG. 3 is a block diagram showing the configuration of the facilities control system according to the fifth embodiment of the present invention. Because the airport control system 1 is the same as in the first embodiment, the description is omitted. FIG. 19 is a block diagram showing another example of the model of the airport ground facilities. In the model of FIG. 19, processes (the priority procedure) when a priority boarding is carried out are modeled when a passenger who is going to board an international line airplane delays in the arrival at the airport in the process of FIG. 13. There is the airport model of FIG. 13 such a passenger, and the process shown in FIG. 19 starts from a priority check-in counter 44a. Also, there is the airport model of FIG. 17 as for the baggage, and the process shown in FIG. 19 starts from the priority check-in counter 44a. Such a model is stored in the simulation model database 8e of the airport simulation apparatus 6. This model is set based on the arrangement of each process and each equipment in an actual airport. However, it is possible to set it virtually.

As for the passenger, there are the priority check-in counter 44a, a priority carrying baggage inspection field 46a, a priority security check inspection field 47a, and a priority departure immigration inspection field 48a, subsequent to a lounge C43 as the nodes (corresponding to 8b-1). Finally, the passenger goes toward the airplane via the boarding gate 50. On the other hand, as the links (corresponding to 8d-1), there are priority passages a15 to a24. However, the priority passage a21 comes from the check-in counter 44 in FIG. 13, the priority passage a22 comes from the carrying baggage inspection field 46 in FIG. 13, and the priority passage a23 comes from the security check inspection field 47 in FIG. 13. Data stored in the node setting database 8b and the link setting database 8d of the simulation data base 8 are used as the capabilities of each node and each link.

As for the baggage, there are a priority explosive sensor inspection field 80a, a priority baggage transportation system 81a, a priority tag check field 83a and a priority transportation cart 84a. On the other hand, as the links (corresponding to 8d-1), there are priority transportation passages g9 to g16. However, the priority transportation passages g14 comes from the explosive sensor inspection field 80 in FIG. 17, the priority transportation passages g15 comes from the baggage transportation system A81 in FIG. 17 and the priority transportation passages g16 comes from the tag check filed A83 in FIG. 17. Data stored in the node setting database 8b, the node setting database 8c, and the link setting database 8d of the simulation data base 8 are used as the capabilities of each node and each link.

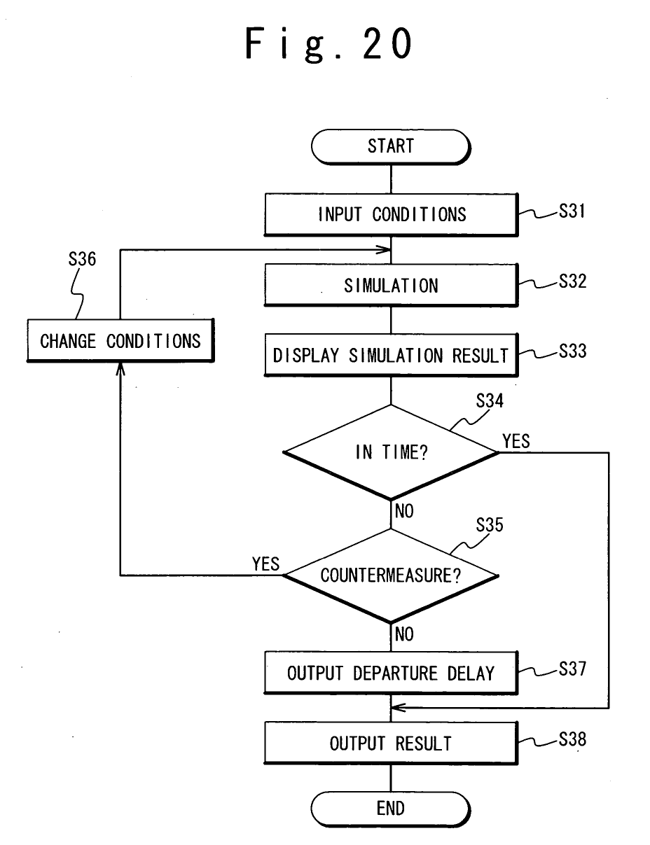

Next, an operation of the facilities control system according to the fifth embodiment of the present invention will be described. FIG. 20 is a flow chart showing the operation of the facilities control system according to the fifth embodiment of the present invention. In this case, the simulation and a proposal of a countermeasure will be described when the airport models of FIG. 13, FIG. 17 and FIG. 19 correspond to an actual airport and the priority boarding is carried out because the passenger who is going to board an international line airplane delays in the arrival at the airport. It should be noted that the simulation is carried out about the departure from the international line as an example. In this simulation, a temporal flow of every object (the target person and the target baggage) is simulated based on the status data.

(1) Step S31

The simulation section 7 reads out the airport model (FIG. 13, FIG. 17 and FIG. 19) from the simulation model database 8e. Also, the status data showing the target person and baggage at current status at each node and each link in the airport are acquired from the flight schedule database 4b of FIG. 5, the status database 4c of FIG. 6 and the capability database 4d of FIG. 7. In addition, the current position (the node or the link) of the passenger A who is going to board and delays in the arrival at the airport is inputted. However, if a virtual data is inputted, the virtual future can be estimated. But, the first simulation is carried out based on the airport model of FIG. 13 and FIG. 17.

(2) Step S32

The simulation section 7 carries out a simulation of the time change in the status data of passenger A and his baggage A by using the airport model based on the status data. The simulation is carried out until the passenger A arrives at the boarding gate and the baggage B is loaded into the airplane. That is, the status data of the passenger A when he arrives at the boarding gate and the status data of the baggage B when it is loaded into the airplane are calculated. This simulation is the same as in the first embodiment.

(3) Step S33

The simulation section 7 displays a future status of the passenger A when he arrives at the boarding gate and a future status of the baggage B when it is loaded into the airplane, on the display unit 11 and stores in the predetermined storage section (not shown). Then, the simulation section 7 outputs their status data to the evaluation section 9.

(4) Step S34

The evaluation section 9 compares the status data of the passenger A and the status data of the baggage A, and the departure time of the airplane on which the passenger A is going to board. When both of the passenger A and the baggage A are in the departure time of the flight, the control flow advances to a step S38. When either of the passenger A and the baggage A is not in departure time, the control flow advances to a step S35.

(5) Step S35

The evaluation section 9 checks whether or not there is a countermeasure to the situation, because either of the passenger A and the baggage A is not in the departure time. In this case, it is determined whether or not there is any priority procedure (FIG. 19) whose simulation is not yet carried out (step S32). In case of presence, the control flow advances to a step S36. In case of absence, the control flows advances to a step S37.

(6) Step S36

The evaluation section 9 adds an airport model shown in FIG. 19 to the airport model. The simulation section 7 carries out the simulation of the priority procedure at the step S32. Through this addition, the simulation section 7 can simulate the situation when either of the passenger A and the baggage A is moved to the passage (the priority procedure) shown by the airport model of FIG. 19 from the way of the airport model of FIG. 13 and FIG. 17. In this case, the simulation is first carried out under the condition that the passenger A moves from the node which is as near the boarding gate as possible to the priority passage. However, when the passenger is not in time, the simulation is next carried out under the condition that the passenger A moves from the node which is near the boarding gate to the priority passage. For example, when the passenger A is in the check-in counter 44, the departure immigration inspection 48 is changed to a priority departure immigration inspection 48a, and the simulation is carried out (step S32). However, when the passenger not in time, the security check inspection 47 is changed to a priority security check inspection 47a and then the simulation is carried out such that the passenger A goes to the priority departure immigration inspection field 48a (step S32). It should be noted that the countermeasure may be inputted from outside.

(7) Step S37

When it is determined that either of passenger A and baggage A is not in the departure time of the flight even if all the priority procedures are used, a delay of the departure time of the flight is calculated based on the status data of the passenger A and the status data of the baggage A. The calculation result is displayed on the display unit 11, is stored in the predetermined storage section (not shown) and is displayed on a flight display unit.

(8) Step S38

When the priority procedures are carried out, the fact is displayed on the display unit 11 and outputted to each node and (portable phones of) concerned staffs such as a captain and flight attendants. When any priority procedure is not carried out, the effect is displayed on the display unit 11 and outputted to (the portable phones of) the concerned persons.

Through the above processes, it is possible to immediately determine what priority procedure should be taken in future, when the arrival of the passenger delays. In addition, when the arrival of the passenger A is not in the departure time of flight, the delay can be displayed to a flight display unit and notified to the concerned staffs. As a result, countermeasure can be speedily taken.

[Sixth Embodiment]

The facilities control system according to the sixth embodiment of the present invention will be described below. FIG. 3 is a block diagram showing the configuration of the facilities control system according to the third embodiment of the present invention. Because this the airport control system 1 is the same as in the first embodiment, the description is omitted. FIG. 13 is a block diagram showing an example of the model of the airport ground facilities. Because this airport model is the same as in the first embodiment, the description is omitted.

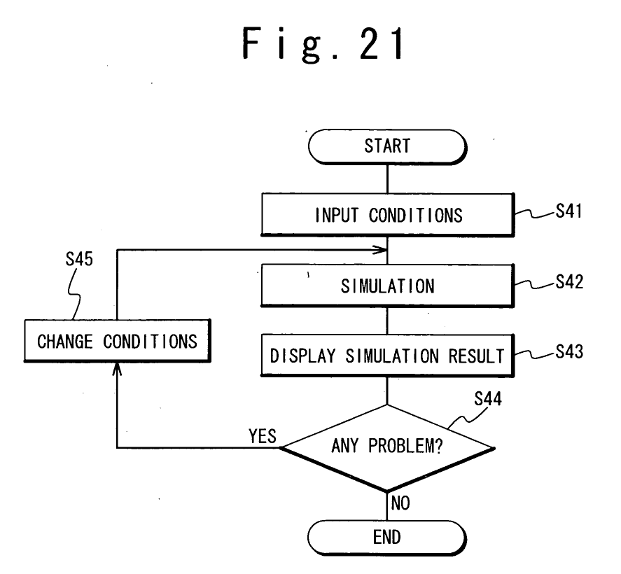

Next, an operation of the facilities control system according to the sixth embodiment of the present invention will be described below. FIG. 21 is a flow chart showing the operation of the facilities control system according to the sixth embodiment of the present invention. A case will be described where the airport model of FIG. 13 corresponds to an actual airport and the simulation is carried out to check whether or not any part of the facilities have a problem. However, the departure from an international line is used as an example of simulation. In this simulation, a temporal flow every annual objects (the target person and the baggage) is simulated based on the status data.

(1) Step S41

The simulation section 7 reads out an airport model (FIG. 13) from the simulation model database 8e. Also, the simulation section 7 acquires the status data showing the target person and baggage at current status at each link and each node in the airport (for example, for past one year) from the status databases 4c of FIG. 6, the capability database 4d of FIG. 7, and the quantity database 8a of FIG. 8. However, if the virtual data is inputted, the virtual future can be estimated. As the virtual data, when the number of flights of departure and arrival increases in future, the number of flights and the number of passengers and baggages expected to increase are used as the data of the status database 4c. Problems estimated to occur in the airport when the number of flights of departure and arrival increases is increased can be simulated.

(2) Step S42

The simulation section 7 carries out a simulation of the time change in the status data by using the airport model based on the status data. The simulation is carried out for one year. That is, the status data is calculated to show the passengers and baggages at each link and each node in the airport for one year state. This simulation is the same as in the first embodiment.

(3) Step S43

The simulation section 7 displays the status data for one year on the display unit 11 and stores in the predetermined storage section (not shown). Also, the simulation section 7 outputs the status data to the evaluation section 9.

(4) Step S44

The evaluation section 9 determines whether any problem is in the statuses of each node and each link and the target passenger and baggage specified by the status data at each node and each link. The determination of presence of the problem is based on the following matters: an equipment operation percentage in each node is equal to or less than 70% and there is too large margin through the year, a congestion percentage of the target passenger and baggages at each link is equal to or less than 70% and there is too large margin through the year, an equipment operation percentage in each node is larger than 100% through the year, and a congestion percentage of the target persons and baggages at each link is larger than 100%. The control flow advances to a step S45 when there is too much margin or the congestion is easy to occur. The control flow ends when the state of too much margin or the congestion is not set at each node and each link.

(5) Step S45

The evaluation section 9 decreases the throughput of each link by a predetermined rate when the margin is too much. The evaluation section 9 increases the throughput of each link by a predetermined rate when the occurrence of congestion is predicted. The predetermined rate is stored in the storage section (not shown). After changing the throughput, the evaluation section 9 advances to the step S42 and carries out the simulation once again. It should be noted that the changed throughput may be inputted from outside.

Through the above processes, the field can be found where there is too much margin at the airport or the congestion is easy to occur. At the same time, it is possible to grasp how much the throughput should be changed to the field. Thus, the facilities and systems in the airport can be optimized.

As described above, the facilities control system using such a model of the airport ground facilities can be applied to the following cases.

(A) When the Congestion of the Passenger is Predicted.

It is predicted that the passengers are crowed in case of departure and arrival delays and strengthening a security. The prediction of the occurrence and change of congestion of the passengers is possible by changing the settings of the above nodes and the links and carrying out a simulation.

When a node or a link is found where the occurrence of congestion is predicted, it is possible to measure by applying appropriate countermeasures to equipments corresponding the nodes or links or equipments corresponding to the upstream or downstream of the node or link. For example, a node or link where the congestion of the passengers is predicted is assumed in the extraordinary situation 10a-1 of the countermeasure database 10a. The following countermeasusres 10a-2 are taken: the increase of throughput (operation percentage) of equipments at the node or link and equipments at the upstream or downstream of the node or link, increase of the number of equipments, operation start of spare equipments, increase of throughputs of staffs, increase of the number of staffs, and open of a spare space.

Thus, it is possible to achieve the avoidance of concentration of the passengers, improvement of satisfaction of passenger, the improvement of the safety of the passengers (avoidance of a panic), shortening of preparation time for departure, and increase of the number of taking-off and landing airplanes.

When a long-range simulation is carried out, it is possible to grasp problems of the facilities and equipments and to optimize the facilities and equipments.

(B) When the Non-Transported State of the Baggages is Predicted

The non-transported status of the baggage is predicted when a departure airplane and an arrival airplane are delayed and a security is strengthened. In this case, it is possible to predict change of non-transported status of the baggages by changing the settings of the above node and the link and by carrying out the simulation. When a node or link is found where the non-transported status of baggage is predicted, an appropriate countermeasure can be applied to equipments corresponding to the node or link or equipments corresponding to upstream or downstream of the node or link. For example, a node or link is found where the non-transported state of baggage is assumed in the extraordinary situation 10a-1 of the database 10-a. In this case, The following countermeasusres 10a-2 are taken: the increase of throughput (operation percentage) of equipments at the node or link and equipments at the upstream or downstream of the node or link, increase of the number of equipments, operation start of spare equipments, increase of throughputs of staffs, increase of the number of staffs, and open of a spare space. Thus, it becomes possible to achieve elimination of the non-transported state of the baggages, the shortening of boarding time for the baggages, earlier notification of departure predicted time, improvement of satisfaction of passengers, and increase of the number of taking-off and landing airplanes.

[Seventh Embodiment]

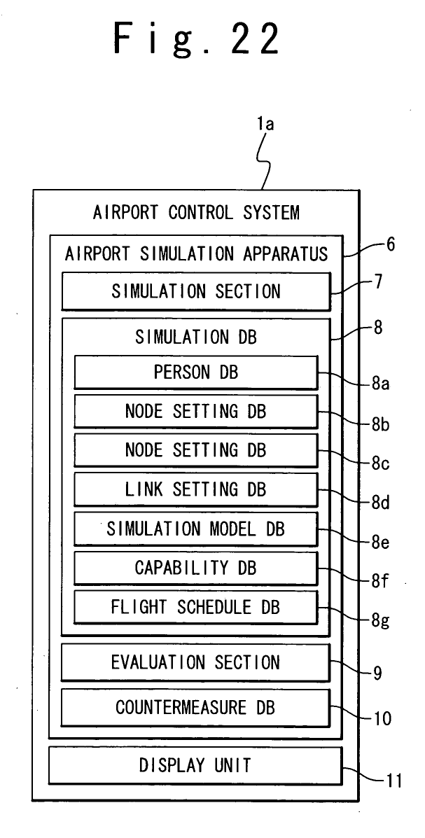

First, the facilities control system according to the seventh embodiment of the present invention will be described. FIG. 22 is a block diagram showing the configuration of the facilities control system according to the seventh embodiment of the present invention. The facilities control system of this embodiment supports an optimal design of an airport by simulating assumed situations. The airport control system 1 is composed of an airport simulation apparatus 6, and a display unit 11. The display unit 11 displays the data of the airport simulation apparatus 6. The airport simulation apparatus 6 is same as that of the first embodiment excluding that the airport simulation apparatus 6 is composed of a capability database 8f, and a flight schedule database 8g. The capability database 8f is the same as the capability database 4d of the first embodiment. The flight schedule database 8g is the same as the flight schedule database 4b of the first embodiment. In this case, both of the databases are temporarily provided for the simulation.

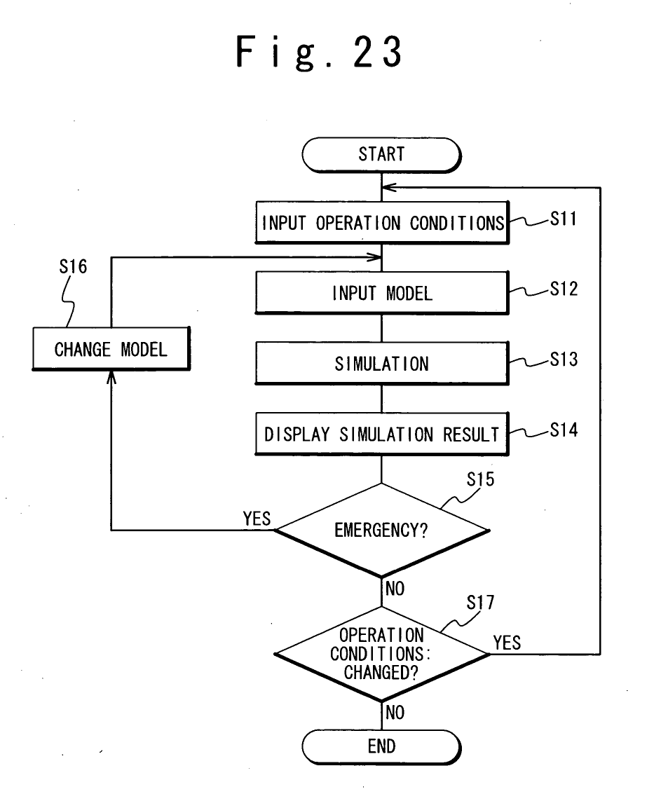

Next, an operation of the facilities control system according to the seventh embodiment of the present invention will be described. FIG. 23 is a flow chart showing the operation of the facilities control system according to the seventh embodiment of the present invention.

(1) Step S11

The simulation section 7 acquires the settings of each node and each link from the node setting database 8b, the node setting database 8c, the link setting database 8d, and the capability database 8f. In addition, the flight data is acquired from the flight schedule database 8g.

(2) Step S12

The simulation section 7 reads out an airport model (e.g., shown in FIG. 13, FIG. 15, FIG. 17, and FIG. 18) from the simulation model database 8e. By inputting the operation conditions at step S11, the airport model is completed.

(3) Step S13

The status data of the passenger and the baggage in case of the departure and the status data of the passenger and the baggage in case of the arrival are acquired from the quantity database 8a by the simulation section 7. In this case, the quantity database 8a shows a value estimated based on the flight schedule database 8g. A simulation is carried out for a future status data based on the current status data, by using the airport model. That is, the future status data is calculated to show statues of the target passenger and baggage at each node and each link in the airport after a predetermined time.

(4) Step S14

The simulation section 7 displays the future status data after the predetermined time on the display unit 11 and stores in the predetermined storage section (not shown). Also, the simulation section 7 outputs the status data to the evaluation section 9.

(5) Step S15

The evaluation section 9 compares the statues of the target person and baggage at each node and each link shown by the status data, and a state of an extraordinary situation (the third conditions) 10a-1. The control flow advances to a step S16 when the extraordinary situation 10a-1 occurs. The control flow advances to a step S17 when the extraordinary situation 10a-1 does not occur.

(6) Step S16

The evaluation section 9 selects one set of the countermeasures 10a-2 corresponding to the estimated situation 10a-1. The evaluation section 9 changes the settings of each node and each link of the airport model based on the countermeasures 10a-2 and stores in the storage section. The control flow advances to the step S12 and the simulation is carried out once again.

(7) Step S17

The simulation section 7 changes operation conditions and repeats the above steps S11 to S16. It should be noted that the simulation of step S13 is as described in the first embodiment.

The facilities control system using such a model of the airport ground facilities can be applied in the following cases.

(C) The Verification of the Design

It is possible to verify whether or not design data of an airport matches to the specifications of the airport. That is, it is possible to verify whether the airport functions to match to the specifications by setting an airport model based on the design data and carrying out the above simulation. Through the preliminary verification, it is possible to prevent the trouble after the airport is built, repair and re-building to eliminate the trouble, and delay of the appointed date. In this case, this facilities control system can be used for the design verification by a specification determination person and also for vender to show the effectiveness of the design data to the specification composer.

(D) The Determination of Design Parameters

The design parameters can be selected through try and error in the simulation to match the specifications of the airport. Thus, the optimal design can be carried out and the exclusion of the redundant design, and the reduction in costs can be attempted. Through the preliminary verification, the trouble after airport is built, the repair and re-building, and delay from an appointed date can be prevented.

(E) The Product Selection

A simulation is carried out using a product of each company and the optimal one matching to the specifications can be selected. Thus, the quality of the product is guaranteed, an optimal design can be carried out and the exclusion of the redundant design and the reduction in costs can be attempted.

As the simulation section 7 described with reference to FIG. 3 and FIG. 22, it is possible to use a tool which simulates the transfer of the data on the network. However, it is supposed that predetermined alterations are applied to the tool. As the tool, QASE available from Veritas is exemplified. This QASE simulates how data spreads on the network which contains a plurality of data processing units, when the data to be processed by one data processing unit is outputted to another data processing unit. For example, when the present invention is applied, it is supposed that the CPU power of the data processing unit is set as the throughput of the node in the present invention, the transmission capability of a communication line is set as the throughput of the link in the present invention and the network is an airport model. Moreover, as the predetermined alternations, in addition to the original functions of QASE, a function is set to change the CPU power and the transmission capability according to the time and the process quantity for the purpose to simulate a process by a person.

According to the present invention, it is possible to estimate a change in the statuses of the facilities in the airport accurately, and it is possible to efficiently and optimally operate the facilities in accordance with the change of the status. Also, in the present invention, the design of the facilities can be carried out efficiently optimally.

1. A facilities control system comprising:
a simulation section which carries out a simulation of a time change of a statusof an object of a target based on a status data showing said target status in said facilities by using a facilities model; and
a display section which displays a simulation result,
wherein said facilities model comprises:
a plurality of nodes, in each of which a process is carried out said target based on a first condition, which is set to the node to determine a throughput of the process in the node, and
a plurality of links, each of which connects between two of said plurality of nodes, and in each of which a process is carried out said target based on a second condition, which is set to the link to determine a throughput of the process in the link.

2. The facilities control system according to claim 1, wherein said simulation section carries out said simulation over all of a plurality of said objects while said target is changed among said plurality of objects.

3. The facilities control system according to claim 1, wherein said first condition set to at least one of said plurality of nodes contains a function of time to indicate a time change of said throughput.

4. The facilities control system according to claim 1, wherein said first condition set to at least one of said plurality of nodes contains a time stayed in said at least node.

5. The facilities control system according to claim 1, wherein said second condition contains a selection probability of one of said links connected with one of said plurality of nodes.

6. The facilities control system according to claim 2, further comprising:
an evaluation section; and
a countermeasure database storing countermeasures to an extraordinary situation,
wherein when said extraordinary situation occurs, said throughput of the process in a specific node of said plurality of nodes is decreased in said simulation, and
said evaluation section compares said statues of said objects and a first threshold, selects one of said countermeasures when said statues of said objects indicate exceeding said first threshold, displays the selected countermeasure on said display section, and drives said simulation section again.

7. The facilities control system according to claim 6, wherein when there are said countermeasures to said extraordinary situation, a priority level is allocated to each of said countermeasures, and
said evaluation section selects one of said countermeasures based on said priority levels.

8. The facilities control system according to claim 1, further comprising:
a simulation database which stores a set of each of said plurality of nodes and said first condition and a set of each of said plurality of links and said second condition,
wherein said facilities model is set based on a plurality of said processes to said target in said plurality of nodes and links of said facilities, and said simulation database.

9. The facilities control system according to claim 2, wherein said facilities is an airport, and
a plurality of said processes in said plurality of nodes and links is either of a set of processes when passengers as said targets board an airplane, a set of processes when baggages of said passengers as said targets is loaded into the airplane, a set of processes when said passengers as said targets get off an airplane, and a set of processes when baggages of said passengers as said targets is unloaded into the airplane.

10. The facilities control system according to claim 1, further comprising:
a model database storing said facilities mode and another facilities model; and
an evaluation section, which evaluates whether said throughput of the process in a specific node of said plurality of nodes is sufficient to said target based on said status of said target in a simulation result, and adds said another facilities model when it is determined to be insufficient, and drives said simulation section again,
wherein said simulation section carries out said simulation by using said facilities model and said another facilities model.

11. The facilities control system according to claim 2, wherein said facilities is an airport,
the facilities control system further comprises:
a flight schedule database storing flight data of departure and arrival airplanes and passengers and baggages of the departure and arrival airplanes, and
a number of said objects is changed based on said flight data during said simulation.

12. A method of controlling facilities, comprising:
simulating a time change of a status of an object of a target based on a status data showing said target status in said facilities by using a facilities model; and
displaying a simulation result,
wherein said facilities model comprises:
a plurality of nodes, in each of which a process is carried out said target based on a first condition, which is set to the node to determine a throughput of the process in the node, and
a plurality of links, each of which connects between two of said plurality of nodes, and in each of which a process is carried out said target based on a second condition, which is set to the link to determine a throughput of the process in the link.

13. The method according to claim 12, wherein said simulating comprises:
simulating over all of a plurality of said objects while said target is changed among said plurality of objects.

14. The method according to claim 12, wherein said first condition set to at least one of said plurality of nodes contains a function of time to indicate a time change of said throughput.

15. The method according to claim 12, wherein said first condition set to at least one of said plurality of nodes contains a time stayed in said at least node.

16. The method according to claim 12, wherein said second condition contains a selection probability of one of said links connected with one of said plurality of nodes.

17. The method according to claim 13, further comprising:
decreasing said throughput of the process in a specific node of said plurality of nodes in said simulation when an extraordinary situation occurs;
comparing said statues of said objects and a first threshold;
selecting one of countermeasures when said statues of said objects indicate exceeding said first threshold;
displaying the selected countermeasure on said display section; and
driving said simulating step again.

18. The method according to claim 17, wherein when there are said countermeasures to said extraordinary situation, a priority level is allocated to each of said countermeasures, and
said selecting comprises:
selecting one of said countermeasures based on said priority levels.

19. The method according to claim 12, further comprising:
setting said facilities model based on a plurality of said processes to said target in said plurality of nodes and links of said facilities, and a simulation database which stores a set of each of said plurality of nodes and said first condition and a set of each of said plurality of links and said second condition.

20. The method according to claim 13, wherein said facilities is an airport, and
a plurality of said processes in said plurality of nodes and links is either of a set of processes when passengers as said targets board an airplane, a set of processes when baggages of said passengers as said targets is loaded into the airplane, a set of processes when said passengers as said targets get off an airplane, and a set of processes when baggages of said passengers as said targets is unloaded into the airplane.

21. The method according to claim 12, further comprising:
evaluating whether said throughput of the process in a specific node of said plurality of nodes is sufficient to said target based on said status of said target in a simulation result;
reading and another facilities model from a simulation database and adding said another facilities model to said facilities model when it is determined to be insufficient; and
simulating the time change of the status of said target by using said facilities model and said another facilities mode.

22. The method according to claim 13, wherein said facilities is an airport, and
changing a number of said objects during said simulation based on said flight data indicative of departure and arrival airplanes and passengers and baggages of the departure and arrival airplanes.

23. A computer-executable software product for achieving the functions of:
simulating a time change of a status of an object of a target based on a status data showing said target status in said facilities by using a facilities model; and
displaying a simulation result,
wherein said facilities model comprises:
a plurality of nodes, in each of which a process is carried out said target based on a first condition, which is set to the node to determine a throughput of the process in the node, and
a plurality of links, each of which connects between two of said plurality of nodes, and in each of which a process is carried out said target based on a second condition, which is set to the link to determine a throughput of the process in the link.

24. The computer-executable software product according to claim 23, wherein the function of simulating comprises:
a function of simulating over all of a plurality of said objects while said target is changed among said plurality of objects.
